(19) United States
(12) Patent Application Publication
(10) Pub. No.: US 2026/0329668 A1
(43) Pub. Date: Oct. 22, 2026

(54) SYSTEM AND METHOD FOR API ORCHESTRATION IN AUTOMOTIVE SYSTEMS

(71) Applicant: TOYOTA JIDOSHA KABUSHIKI KAISHA, Toyota-shi (JP)

(72) Inventors: Jean-François BASTIEN, Tokyo (JP); Nikolaos MICHALAKIS, Trieste (IT)

(73) Assignee: TOYOTA JIDOSHA KABUSHIKI KAISHA, Toyota-shi (JP)

(21) Appl. No.: 19/180,329

(22) Filed: Apr. 16, 2025

(51) Int. Cl. G06F 9/54

(52) U.S. Cl. CPC G06F 9/54; G06F 2209/543

(57) ABSTRACT

Provided are a method, system, and device for extending an operating system of a vehicle. The method may include receiving, by an orchestrator, a first Application Programming Interface (API) from a first external device; receiving, by an orchestrator, a second API from a second external device; and executing, by the orchestrator, a handshake process between the first external device and the second external device based on the received first API and second API.

### FIELD

Example embodiments of the present disclosure relate to application programming interface (API) orchestration for operating system (OS) extendibility in automotive systems.

### BACKGROUND

In the related art, vehicles may implement an operating system (OS) in order to perform functions on hardware within the vehicle. For example, the vehicle's OS may implement onboard entertainment systems, which may pair with a user's external device (e.g., a smartphone) in order to perform hands-free calls, or play music from the user's external device.

However, a vehicle's OS in the related art may contain many limitations in terms of fixed functionality and lack of common protocol with external devices. This is since external devices commonly have third party protocols (relative to the vehicle OS), and for example, the application program interfaces (API's) implemented for the external device may limit the hardware it can be connected to. This may be further complicated if the external device has a system update (independent of the vehicle), such that it may no longer be able to connect to the vehicle. There may also be security concerns of connecting external devices to the vehicle, since it may expose the vehicle's core systems to the external device. Accordingly, the vehicle may not be able to connect to all devices based on the limitations of its OS.

Accordingly, there is a need to be able to extend the vehicle OS's operability to include more external devices.

### SUMMARY

Example embodiments consistent with the present disclosure provide a process for extending the operating system (OS) of a vehicle. The method may include receiving, by an orchestrator, a first Application Programming Interface (API) from a first external device; receiving, by an orchestrator, a second API from a second external device; and executing, by the orchestrator, a handshake process between the first external device and the second external device based on the received first API and second API.

It can be understood that example embodiments of the present disclosure allow for the vehicle OS to be able to interact with a wider range of external devices since the API received on a per-device basis, thereby improving extendibility of the vehicle OS.

According to embodiments, the first external device may include a slave device and the second external device comprises a master device. The first external device may include an embedded limitation and the second external device comprises a token, wherein the embedded limitation is configured based on detecting the token. The embedded limitation may include enabling the first external device based on detecting the presence of the token. Alternatively or additionally, the embedded limitation comprises modifying a setting in the first external device based on detecting the presence of the token.

According to embodiments, the method may further include scheduling, by the orchestrator, a first service for the first external device based on first API; and scheduling, by the orchestrator, a second service for the second external device based on the second API after the first service. The method may further include combining, by the orchestrator, the first service and the second service into a third service.

Additional aspects will be set forth in part in the description that follows and, in part, will be apparent from the description, or may be realized by practice of the presented embodiments of the disclosure.

### BRIEF DESCRIPTION OF THE DRAWINGS

Features, advantages, and significance of exemplary embodiments of the disclosure will be described below with reference to the accompanying drawings, in which like reference numerals denote like elements, and wherein:

FIG. 1 illustrates an example system architecture diagram, according to one or more example embodiments;

FIG. 2 illustrates an example master-slave configuration for an orchestrator, according to one or more example embodiments;

FIG. 3 illustrates an example method for extending vehicle OS, according to one or more example embodiments; and

FIG. 4 illustrates a diagram of an example components of a system that may be configured to implement one or more example embodiments.

### DETAILED DESCRIPTION

The following detailed description of exemplary embodiments refers to the accompanying drawings. The foregoing disclosure provides illustration and description but is not intended to be exhaustive or to limit the implementations to the precise form disclosed. Modifications and variations are possible in light of the above disclosure or may be acquired from practice of the implementations. Further, one or more features or components of one embodiment may be incorporated into or combined with another embodiment (or one or more features of another embodiment). Additionally, in the flowcharts and descriptions of operations provided below, it is understood that one or more operations may be omitted, one or more operations may be added, one or more operations may be performed simultaneously (at least in part), and the order of one or more operations may be switched.

Even though particular combinations of features are recited in the claims and/or disclosed in the specification, these combinations are not intended to limit the disclosure of possible implementations. In fact, many of these features may be combined in ways not specifically recited in the claims and/or disclosed in the specification. Although each dependent claim listed below may directly depend on only one claim, the disclosure of possible implementations includes each dependent claim in combination with every other claim in the claim set.

No element, act, or instruction used herein should be construed as critical or essential unless explicitly described as such. Also, as used herein, the articles “a” and “an” are intended to include one or more items, and may be used interchangeably with “one or more.” Where only one item is intended, the term “one” or similar language is used. Also, as used herein, the terms “has,” “have,” “having,” “include,” “including,” or the like are intended to be open-ended terms. Further, the phrase “based on” is intended to mean “based, at least in part, on” unless explicitly stated otherwise. Furthermore, expressions such as “[A] and/or [B]”, “at least one of [A] and [B]” or “at least one of [A] or [B]” are to be understood as including only A, only B, or both A and B.

Expressions such as “at least one processor,” where configured to implement a plurality of operations, execute a plurality of instructions, etc., are to be understood as a single processor implementing the plurality of operations, etc., or each of plural processors implementing at least some (but not necessarily all) of the plurality of operations, etc.

Reference throughout this specification to “one embodiment,” “an embodiment,” “non-limiting exemplary embodiment,” or similar language means that a particular feature, structure, or characteristic described in connection with the indicated embodiment is included in at least one embodiment of the present solution. Thus, the phrases “in one embodiment”, “in an embodiment,” “in one non-limiting exemplary embodiment,” and similar language throughout this specification may, but do not necessarily, all refer to the same embodiment.

Further, the described features, advantages, and characteristics of the present disclosure may be combined in any suitable manner in one or more example embodiments. One skilled in the relevant art will recognize, in light of the description herein, that the present disclosure can be practiced without one or more of the specific features or advantages of a particular embodiment. In other instances, additional features and advantages may be recognized in certain embodiments that may not be present in all embodiments of the present disclosure.

Furthermore, the term “vehicle” described herein refers to any suitable type of vehicle in which example embodiments of the present disclosure can be implemented. For instance, the “vehicle” may refer to a motorized vehicle such as a car, a truck, a bus, a motorcycle, or any other suitable type of automobile powered by an engine, motor, or other mechanical means. Alternatively or additionally, the “vehicle” described herein may refer to a bicycle, a skateboard, and any other suitable types of non-motorized vehicle, without departing from the scope of the present disclosure.

According to example embodiments, a method for extending the operating system (OS) of a vehicle may be provided. The method may include receiving, by an orchestrator, a first Application Programming Interface (API) from a first external device; receiving, by an orchestrator, a second API from a second external device; and executing, by the orchestrator, a handshake process between the first external device and the second external device based on the received first API and second API.

Based on the above, it can be understood that example embodiments of the present disclosure allow for the vehicle OS to be able to interact with a wider range of external devices since the API received on a per-device basis, thereby improving extendibility of the vehicle OS.

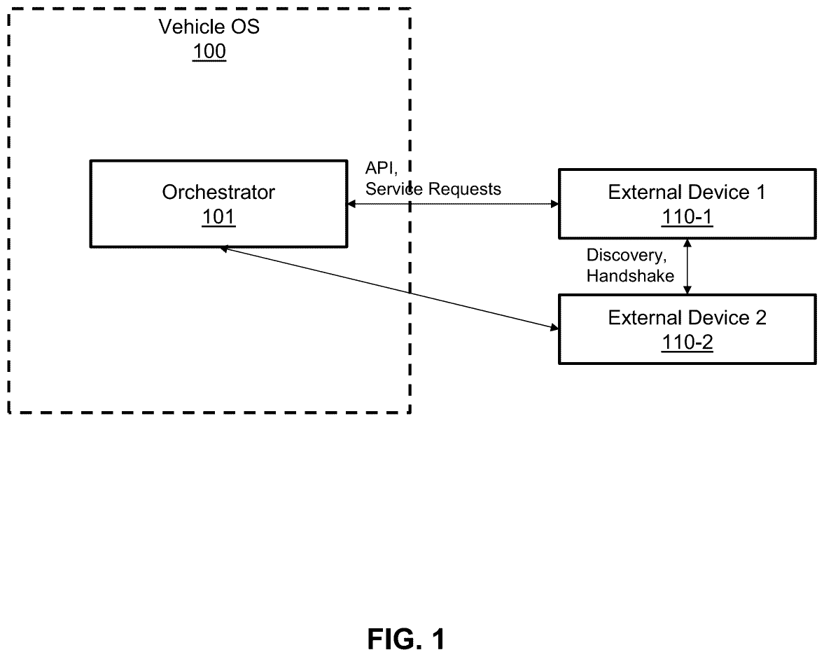

FIG. 1 illustrates an example system architecture diagram, according to one or more example embodiments.

Referring to FIG. 1, vehicle OS 100 implementing orchestrator 101 may be provided. Orchestrator 101 may be configured to communicate with one or more external devices 110-1 and 110-2, in order to receive API and service requests, and perform scheduling/management tasks for services corresponding to external devices 110-1 and 110-2.

Based on orchestrator 101, external device 1 110-1 and external device 2 110-2 may be discoverable to each other, and may perform a handshake procedure in order to perform communication with each other directly. According to example embodiments, the details regarding the handshake procedure may be included in the API's provided by external device 110-1 and external device 110-2 respectively. Accordingly, orchestrator 101 may firstly receive said API's, and then initiate/enable discovery for the external device 110-1 and 110-2, and subsequently initiate the handshake procedure between external devices 110-1 and 110-2.

External devices 110-1 and 110-2 may be any device which is not part of the vehicle's own hardware. For example, it may include peripherals such as a siren, or a GPS tracker. It should be appreciated that although the term “external” is used, the external device 110-1 and 110-2 may not necessarily be located physically outside of the vehicle. For example, if the external device 110-1 and 110-2 is a user's smartphone, it may still be inside of the vehicle during operation.

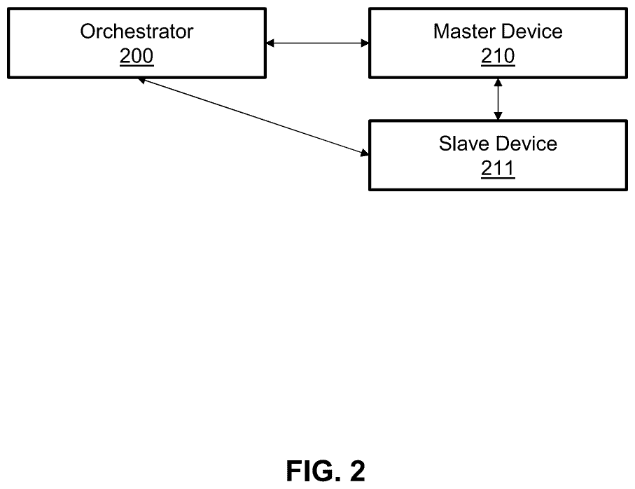

As an example of implementing the architecture in FIG. 1, external device 110-1 may be a vehicle underglow LED with configurable colors, whereas external device 110-2 may be a dashboard toy which lights up with LED's with configurable colors. Although they may have different API's, Orchestrator 101 may detect both external devices, receive their API's, and coordinate lights for both external device 110-1 and 110-2 to be synchronized. For example, the synchronization may be configured directly with the orchestrator 101 itself, or the instructions can be sent from one of the external devices (e.g., external device 110-1 to external device 110-2) as a master-slave configuration (such as in FIG. 2 illustrated below).

FIG. 2 illustrates an example master-slave configuration for an orchestrator, according to one or more example embodiments.

An orchestrator 200 may be configured to perform orchestration tasks for master device 210 and for slave device 211. It should be appreciated that while only one master device 210 and slave device 211 is illustrated, more devices can be included depending on the specific use-case.

Master device 210 may be configured to write messages, whereas slave device 211 may be configured to read messages, depending on the specific implementation. According to embodiments, master device 210 and slave device 211 may be discoverable to each other to run executables.

Slave device 211 may be configured to have an embedded limitation, based on the presence of a token in master device 210. As an example, an emergency vehicle may have sirens and lights installed as slave device 211, whereas an emergency radio or a GPS tracker may be installed as a master device 210. Based on configuration from orchestrator 200, and the presence of a token on master device 210, the sirens and lights for slave device 211 may have an embedded limitation to enable themselves, or turn to a specific color based on detecting the token in the emergency radio or GPS tracker (e.g., the token is based on a specific radio code being received, or the GPS tracker is in a particular location).

According to embodiments, the embedded limitation in slave device 211 may be brand specific. For example, upon detecting the token, the slave device 211 may change its visual display appearance or theme based on branding detected in master device 210 in its token.

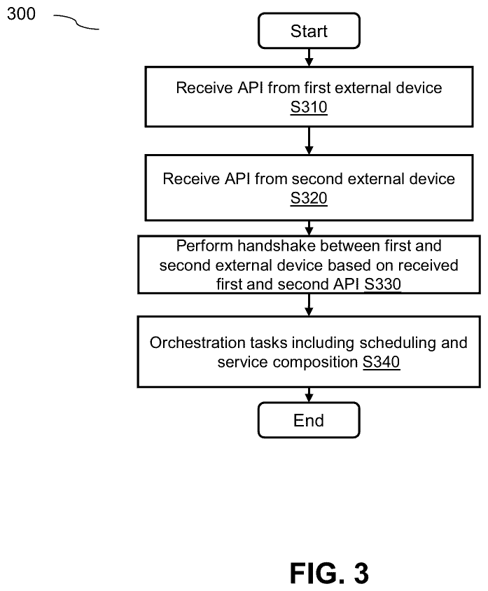

FIG. 3 illustrates an example method 300 for extending vehicle OS, according to one or more example embodiments.

At operation S310, a first API may be received by the orchestrator from a first external device. According to embodiments, the first external device may be a slave device. The first external device may include an embedded limitation.

At operation S320, a second API (which may be different or the same as the first API) may be received by an orchestrator from a second external device. According to embodiments, the second external device may be a master device and may include a token. The embedded limitation in the first external device may be configured based on detecting the token. For example, the embedded limitation may include enabling the first external device based on detecting the presence of the token, or modifying a setting in the first external device based on detecting the presence of the token.

At operation S330, the orchestrator may initiate a handshake between the first and the second external devices, which may be based on the protocols received in the first and the second API's from operation S310 and operation S320.

At operation S340, the orchestrator may perform additional scheduling and service composition tasks. For example, it may include scheduling a first and second service in the first and second external devices based on their respective API's based on this workflow management, the order and interaction of services may be able to meet specific requirements. According to embodiments, it may include combining the first and the second services into a third service. Based on this service composition, multiple services may be combined in order to achieve a complex functionality. According to embodiments, the orchestrator may allow for the systems to adapt to new services and demands without extensive reconfiguration, thereby improving scalability of the system.

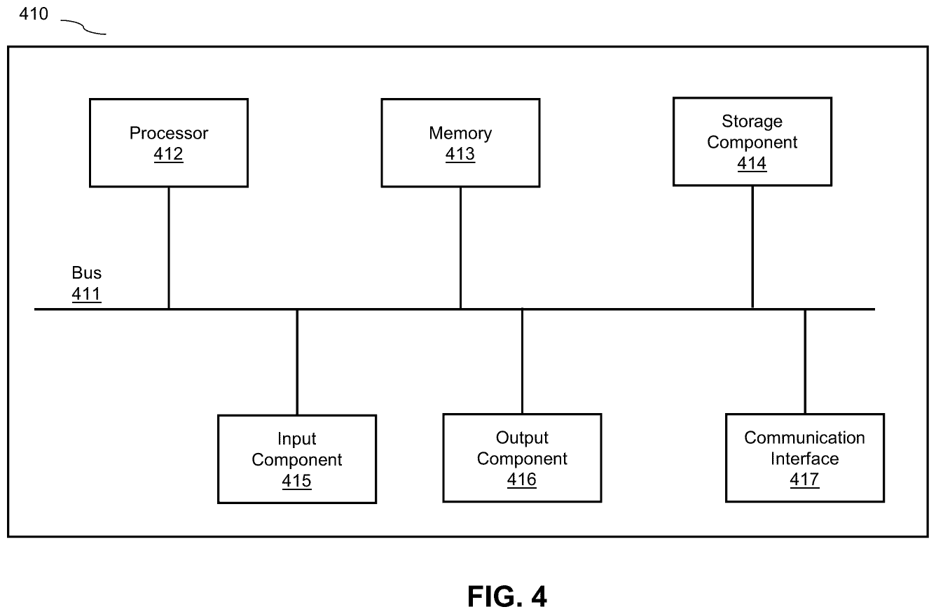

FIG. 4 illustrates a diagram of example components of a system, according to one or more example embodiments. As illustrated in FIG. 4, the system 410 may include at least one bus 411, at least one processor 412, at least one memory 413, at least one storage component 414, at least one input component 415, at least one output component 416, and at least one communication interface 417.

It is contemplated that the system 410 may include more or less components than illustrated in FIG. 4, without departing from the scope of the present disclosure. For instance, in some embodiments, the system 410 may include a plurality of storage components 414, the input component 415 and the output component 416 may be implemented as a transceiver component, the memory 413 and storage component 414 may be implemented as a memory storage, and the like.

The bus 411 may be configured to facilitate or enable communications among the components of the system 410. Specifically, the bus 411 may communicatively couple the components to each other and provide a means for data transfer and flow of control signals between the components. The bus 411 may include one or more of: an internal bus, an address bus, a data bus, a control bus, a controller area network (CAN) bus, an Ethernet bus, a peripheral component interconnect express (PCIe) bus, and any other suitable type of bus that can be implemented in the system 410 to enable communication and coordination between the components within the system 410 in real-time (or near real-time).

The processor 412 may be implemented in hardware, firmware, or a combination of hardware and software, and may be configured to handle real-time (or near real-time) data processing and control of the control system 410. The processor 412 may include one or more of: a central processing unit (CPU), a graphics processing unit (GPU), a neural processing unit (NPU), a tensor processing unit (TPU), an accelerated processing unit (APU), a microprocessor, a microcontroller, a digital signal processor (DSP), a field-programmable gate array (FPGA), an application-specific integrated circuit (ASIC), and/or another type of processing or computing component that can be implemented in the system 410. In some implementations, the processor 412 may be capable of being programmed to perform one or more operations described herein. Further, the processor 412 may include a plurality of processing units, each of which is dedicated to performing a specific operation.

The memory 413 may include one or more mediums for storing temporary data, runtime variables, program instructions, and buffers required for the operations of the control system 410. The memory 413 may include one or more of: a flash memory, a read-only memory (ROM), a random-access memory (RAM), a dynamic or static storage device (e.g., a flash memory, a magnetic memory, and/or an optical memory), any other suitable type of memory that can be implemented in the system 410 to store information and/or instructions for use by the processor 412.

The storage component 414 may be configured to store non-volatile data, such as firmware, configuration settings, calibration data, information, and/or software related to the operation and use of the system 410. For example, the storage component 414 may include a hard disk (e.g., a magnetic disk, an optical disk, a magneto-optic disk, and/or a solid state disk), a compact disc (CD), a digital versatile disc (DVD), a floppy disk, a cartridge, a magnetic tape, and/or another type of non-transitory computer-readable medium, along with a corresponding drive.

According to embodiments, the storage component 414 may be configured to store computer-readable or computer-executable instructions for implementing one or more operations of the system 410. The storage component 414 may provide the stored information to the memory 413 for the execution of the processor 412.

The input component 415 may include one or more input components that permit the system 410 to receive information, such as via user input (e.g., a touch screen display, a keyboard, a keypad, a mouse, a button, a switch, and/or a microphone). The output component 416 may include one or more output components that provide output information from the system 410 (e.g., a display, a speaker, a navigation device, one or more light-emitting diodes (LEDs), etc.) According to embodiments, the input component 415 and/or the output component 416 may be optional and may be excluded from the system 410.

The at least one communication interface 417 may include a transceiver-like component (e.g., a transceiver and/or a separate receiver and transmitter) that enables the system 410 to communicate with other components (e.g., ECUs, user devices, etc.), such as via a wired connection, a wireless connection, or a combination of wired and wireless connections. For example, communication interface 417 may include a controller area network (CAN) bus interface, an Ethernet interface, an optical interface, a coaxial interface, an infrared interface, a radio frequency (RF) interface, a universal serial bus (USB) interface, a Wi-Fi interface, a cellular network interface, or the like.

According to one or more embodiments, the communication interface 417 may include at least one input/output (I/O) interface, at least one network interface, at least one storage interface, or the like, that enable the components 412-414 to communicate with other components. Further, the communication interface 417 may include one or more application programming interfaces (APIs) that allow the system 410 (or one or more components included therein) to communicate with one or more software applications (e.g., software application deployed in the ECUs, etc.)

Computer-executable instructions (e.g., software instructions, etc.) may be read into memory 413 and/or storage component 414 from another computer-readable medium or from another device (e.g., a remote server, an external storage, etc.) via, for example, the communication interface 417. When executed, the computer-executable instructions stored in memory 413 and/or storage component 414 may cause the processor 412 to perform one or more processes described herein. Additionally, or alternatively, hardwired circuitry may be used in place of or in combination with software instructions to perform one or more processes described herein. Thus, implementations described herein are not limited to any specific combination of hardware circuitry and software.

Based on the above, it can be understood that example embodiments of the present disclosure allow for the vehicle OS to be able to interact with a wider range of external devices since the API received on a per-device basis, thereby improving extendibility of the vehicle OS.

It is contemplated that features, advantages, and significances of example embodiments described hereinabove are merely a portion of the present disclosure, and are not intended to be exhaustive or to limit the scope of the present disclosure. Further descriptions of the features, components, configuration, operations, and implementations of example embodiments of the present disclosure, as well as the associated technical advantages and significances, are provided in the following.

It is understood that the specific order or hierarchy of blocks in the processes/flowcharts disclosed herein is an illustration of example approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not meant to be limited to the specific order or hierarchy presented.

Some embodiments may relate to a system, a method, and/or a computer-readable medium at any possible technical detail level of integration. Further, as described hereinabove, one or more of the above components described above may be implemented as instructions stored on a computer readable medium and executable by at least one processor (and/or may include at least one processor). The computer-readable medium may include a computer-readable non-transitory storage medium (or media) having computer-readable program instructions thereon for causing a processor (or processors) to carry out operations.

The computer readable storage medium can be a tangible device that can retain and store instructions for use by an instruction execution device. The computer-readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer-readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer-readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer-readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program code/instructions for carrying out operations may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object-oriented programming languages such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects or operations.

These computer readable program instructions may be provided to a processor of a SoC, a general-purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer-readable storage medium that can direct a computer, a programmable data processing apparatus, and/or other devices to function in a particular manner, such that the computer-readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or another device to cause a series of operational steps to be performed on the computer, other programmable apparatus or other device to produce a computer-implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer-readable media according to various embodiments. In this regard, each block in the flowchart or block diagrams may represent a module, segment, or portion of instructions, which comprises one or more executable instructions for implementing the specified logical function(s). The method, computer system, and computer-readable medium may include additional blocks, fewer blocks, different blocks, or differently arranged blocks than those depicted in the Figures. In some alternative implementations, the functions noted in the blocks may occur out of the order noted in the Figures. For example, two blocks shown in succession may, in fact, be executed concurrently or substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

It will be apparent that systems and/or methods, described herein, may be implemented in different forms of hardware, firmware, or a combination of hardware and software. The actual specialized control hardware or software code used to implement these systems and/or methods is not limiting of the implementations. Thus, the operation and behavior of the systems and/or methods were described herein without reference to specific software code-it being understood that software and hardware may be designed to implement the systems and/or methods based on the description herein.

What is claimed is:

1. A method for extending an operating system (OS) of a vehicle, comprising:
receiving, by an orchestrator, a first Application Programming Interface (API) from a first external device;
receiving, by an orchestrator, a second API from a second external device; and
executing, by the orchestrator, a handshake process between the first external device and the second external device based on the received first API and second API.

2. The method as claimed in claim 1, wherein the first external device comprises a slave device and the second external device comprises a master device.

3. The method as claimed in claim 2, wherein the first external device comprises an embedded limitation and the second external device comprises a token, wherein the embedded limitation is configured based on detecting the token.

4. The method as claimed in claim 3, wherein the embedded limitation comprises enabling the first external device based on detecting the presence of the token.

5. The method as claimed in claim 3, wherein the embedded limitation comprises modifying a setting in the first external device based on detecting the presence of the token.

6. The method as claimed in claim 1, wherein the method further comprises:
scheduling, by the orchestrator, a first service for the first external device based on first API; and
scheduling, by the orchestrator, a second service for the second external device based on the second API after the first service.

7. The method as claimed in claim 6, wherein the method further comprises:
combining, by the orchestrator, the first service and the second service into a third service.

8. An orchestrator for extending an operating system (OS) of a vehicle, configured to:
receive a first Application Programming Interface (API) from a first external device;
receive a second API from a second external device; and
execute a handshake process between the first external device and the second external device based on the received first API and second API.

9. The orchestrator as claimed in claim 8, wherein the first external device comprises a slave device and the second external device comprises a master device.

10. The orchestrator as claimed in claim 9, wherein the first external device comprises an embedded limitation and the second external device comprises a token, wherein the embedded limitation is configured based on detecting the token.

11. The orchestrator as claimed in claim 10, wherein the embedded limitation comprises enabling the first external device based on detecting the presence of the token.

12. The orchestrator as claimed in claim 10, wherein the embedded limitation comprises modifying a setting in the first external device based on detecting the presence of the token.

13. The orchestrator as claimed in claim 8, further configured to:
schedule a first service for the first external device based on first API; and
schedule a second service for the second external device based on the second API after the first service.

14. The orchestrator as claimed in claim 13, further configured to:
combine the first service and the second service into a third service.

15. A non-transitory computer-readable recording medium having recorded thereon instructions to perform a method for extending an operating system (OS) of a vehicle, comprising:
receiving, by an orchestrator, a first Application Programming Interface (API) from a first external device;
receiving, by an orchestrator, a second API from a second external device; and
executing, by the orchestrator, a handshake process between the first external device and the second external device based on the received first API and second API.

16. The non-transitory computer-readable recording medium as claimed in claim 15, wherein the first external device comprises a slave device and the second external device comprises a master device.

17. The non-transitory computer-readable recording medium as claimed in claim 16, wherein the first external device comprises an embedded limitation and the second external device comprises a token, wherein the embedded limitation is configured based on detecting the token.

18. The non-transitory computer-readable recording medium as claimed in claim 17, wherein the embedded limitation comprises enabling the first external device based on detecting the presence of the token.

19. The non-transitory computer-readable recording medium as claimed in claim 17, wherein the embedded limitation comprises modifying a setting in the first external device based on detecting the presence of the token.

20. The non-transitory computer-readable recording medium as claimed in claim 15, wherein the method further comprises:
scheduling, by the orchestrator, a first service for the first external device based on first API; and
scheduling, by the orchestrator, a second service for the second external device based on the second API after the first serv
